(19) United States
(12) Patent Application Publication
(10) Pub. No.: US 2014/0372161 A1
(43) Pub. Date: Dec. 18, 2014

(54) Method for Generating a Discrete Forecasted Staff Report

(71) Applicant: Wal-Mart Stores, Inc., Bentonville, AR (US)

(72) Inventors: Richard Bennett Ulrich, Bentonville, AR (US); Charles Brandon Fletcher, Bentonville, AR (US); Christopher James Nowlin, Bentonville, AR (US)

(21) Appl. No.: 13/915,801

(22) Filed: Jun. 12, 2013

(51) Int. Cl. G06Q 10/06

(52) U.S. Cl. CPC G06Q 10/063118
USPC 705/7.17

(57) ABSTRACT

A computer-implemented method is disclosed for generating a discrete forecasted staff report. The method commences with the definition of a set of shifts, each shift having daily and weekly time segments. Using these shifts, “baseline staff” coverage in then inputted into a work schedule to thereby meet, represent, or otherwise define an employer's current staff. Similarly, “projected staff” coverage is then determined in anticipation of meeting, representing, or otherwise defining a future staffing demand. With both “baseline staff” and “projective staff” in place, variance between the two is then calculated discretely throughout the work schedule for each daily and weekly time segment. The forecasted staff report is then generated such that the staffing information provided therein (such as, hiring suggestions) is composed as a function of preferably both (a) the variance and (b) at least one predefined staffing constraint.

### FIELD

The present invention is directed, in general, to means for assessing and addressing the future staffing needs of an employer, and in particular, to a computer-implemented method for generating a discrete forecasted staff report.

### BACKGROUND

Companies and organizations with large widely dispersed employee populations often consume substantial costs to maintain staffing levels appropriate for continuing operations. These costs are particularly elevated for global retailers, exacerbated by the breadth of their operations and the seasonality of their staffing needs.

Large global retailers often have full-time permanent employee populations numbering several tens of thousands of individuals, staffing hundreds of stores and retail facilities, across a dozen or more nations. The employee population in the retail industry is, moreover, often subject to considerable flux, caused for example by seasonal demand for retail merchandise, cyclical labor supply (and other less predictable macroeconomic factors); and customary employee turnover (i.e., by promotion, attrition, transfer, and/or reassignment). Staffing such a large and dynamic employee population is a challenge.

Staffing practices differ from company to company. Some companies may, for example, centralize all staffing decisions, whilst others—typically the larger companies—delegate varying levels of staffing authority to their local branches and divisions. Regardless of these and other differences, staffing activities are now often executed with the assistance of commercially developed staffing software. In respect of new and/or temporary hiring activities, several potentially useful functions offered through such software include: applicant tracking, online application processing, automated resume analysis and parsing, and the tracking and scheduling of current employees.

While the known software solutions continue to be employed, need has recently been identified for functionality specifically targeted towards assessing current staffing levels in view of possible future demands, as well as providing staffing suggestions for filling any potential future deficits. Such functionality is not found in any of the known software solutions, which by and large have comparatively shallow forward-looking capabilities, and seemingly focus predominantly on staff that is already in place.

Such shortcomings are keenly felt, in particular, in hiring activities within foreign jurisdictions that require certain discrete information—such as a contract employee's specific work schedule—to be articulated in a candidate's employment contract. Unfortunately, to comply with such laws, an employer would need to identify and define its future staffing needs at a granularity that currently cannot be attained directly, practically, or efficiently through the known staffing software solutions.

There is thus clearly a need for a better approach towards identifying and addressing an employer's future staffing needs.

### SUMMARY

The invention herein provides a computer implemented method for generating a discrete forecasted staff report. The method commences with the definition of a set of shifts, each shift having daily time segments and weekly time segments. Using these shifts, “baseline staff” coverage is then inputted into a work schedule, to thereby represent or otherwise define an employer's current staff. Similarly, “projected staff” coverage for said work schedule is then determined in anticipation of meeting, representing, or otherwise defining a future staffing demand. With both “baseline staff” and “projective staff” in place, variance between the two is then calculated throughout the work schedule for each daily and weekly time segment (i.e., “discretely”). Finally, the forecasted staff report is generated, the staff report comprising information composed as a function of preferably both (a) the variance and (b) at least one predefined staffing constraint (e.g., a regulatory or financial constraint).

The information in the forecasted staffing report preferably includes a staffing suggestion that is: computed to match the calculated variance; influenced by the staffing constraint(s); and comprising one or a combination of shifts selected from the predefined set thereof.

In certain preferred embodiments, the “projected staff coverage” is computed based on, for example, a forward-looking heuristic algorithm, a predefined staffing template, and/or a calculated average of historical staffing data.

And, in still other preferred embodiments, the baseline staff is inputted automatically through the local importation of staffing data that is stored and maintained by the employer for purposes of customary record-keeping at a remote central employee database.

In sum, it is a principal object of the invention to provide a method for generating a discrete forecasted staff report.

It is another principal object of the invention to provide computer implemented means for discretely identifying and resolving variance between baseline staff coverage and projected staff coverage.

It is another objective to provide methodologies incorporable into staffing software to thereby enable the identification of potential future staffing deficits.

It is another objective to provide methodologies for providing staffing suggestions for filling or otherwise addressing potential future staffing shortages, the staffing suggestions being based on an employer pre-exiting work shift definitions.

And, it is another objective to provide methodologies for providing staffing suggestions for filling or otherwise addressing potential future staffing needs, the staffing suggestions being based on an employer's preexisting work shift definitions and certain predefined employer staffing constraints.

For a further understanding of the nature and objects of the invention, reference should be had to the following description taken in conjunction with the Example provided further below.

### DETAILED DESCRIPTION

The present invention provides a computer implemented method for generating a forecasted staff report, the method comprising the steps of: defining a set of shifts, each shift having daily time segments and weekly time segments; inputting baseline staff covering a work schedule using said set of shifts to represent current staff; providing projected staff anticipated to cover said work schedule to meet a future staffing demand; calculating variance between the baseline staff and the projected staff for each daily and weekly time segment; and providing the forecasted staff report, the report comprising information composed as a function of said variance and—in preferred embodiments—at least one predefined staffing constraint.

Implementation of the method can be accomplished using a single personal computer or across a plurality of networked computers. The computer(s) can each comprise, for example, one or more general purpose processors (such as 8-64 bit microprocessors, RISC-based microprocessors, multi-core processors, digital signal processing chips, etc.); one or more input devices (such as mouse and/or keyboard); one or more output devices (such as a display device and/or printer); one or more data storages devices (such as a disk drive, flash drive, EEPROM, etc.); and associated software (providing for example an operating system and applications).

Although the computing resources used to implement the method can be contained in one central logical or physical locations (i.e., a single computer), for deployment at an enterprise scale, the computer resources will have a correspondingly vast scale, with data assets and work load distributed throughout several network sites. For example, a user interface for the inventive method could be provided at several personal computers, baseline staff data could be stored within local network resources; and templates, algorithms, and staffing forecasts can draw upon resources at a remote central network facility.

Where a network is employed, the network can comprise a plurality of interconnected computers and terminals, servers, data storage facilities, hubs, routers, switches, network security devices, network management devices, wireless nodes and access points, load balancers, and related software. Within such network, all data relating to staffing and employment, or as needed for the invention, can stored within the network's data storage facilities, with web or other data serving facilities publishing to local terminals a user interface for accessing and driving the inventive method, drawing upon, interacting with, and providing access to the stored data.

The data storage facilities can comprise one or more data storage devices capable of recording and retrieving digital information from a medium (e.g., magnetic, optical, semiconductor, etc.). For small to medium-scale employers, the data storage facilities can utilize storage with comparatively modest capacity, such as provided by a single internal or external hard drive or flash drive. For large global employers, the data storage facilities will require greater capacity and bandwidth, and thus, may employ several networked and attached electronic data storage components, these being deployed at an enterprise-scale and may include, for example, arrays of data servers and file servers; SAN and NAS storage facilities; RAID storage systems, data backup, archiving, and redundancy facilities; and data management and load balancing agents.

As indicated, the inventive method commences with the definition of a set of shifts, each comprising daily time segments and weekly time segments.

There is no particularly critical limitation on either the number of shifts or to the number of daily or weekly time segments. The number of shifts can be anywhere from two or more shifts. The daily time segments can be in hours, blocks of hours, 30 minute blocks, fifteen minute blocks, 90 minute blocks, etc. The time segments need not be the same length each. They can be consecutive or non-consecutive. And, as to the weekly time segments, one can use a 5 day week, a seven day week, or other division based on or otherwise tracking an employer's customary staffing practice. Illustrative examples of particular shift definitions are provided in the following table.

| Shift Definition A | | | Shift Definition B | | | Shift Definition C | | |
|---|---|---|---|---|---|---|---|---|
| | Daily | Days | | Daily | Days | | Daily | Days |
| | Shift | Per | | Shift | Per | | Shift | Per |
| Shift | Time^{(A)} | Week | Shift | Time^{(B)} | Week | Shift | Time^{(C)} | Week |
| FT-1 | 9 Hrs. | 5 Days | FT-1 | 440 Min. | 6 Days | FT-1 | 440 Min. | 6 Days |
| FT-2 | 8 Hrs. | 6 Days | FT-2 | 528 Min. | 5 Days | FT-2 | 528 Min. | 5 Days |
| PT-1 | 4 Hrs. | 5 Days | PT-1 | 240 Min. | 5 Days | PT-1 | 240 Min. | 5 Days |
| PT-2 | 5 Hrs. | 4 Days | PT-2 | 300 Min. | 4 Days | PT-2 | 300 Min. | 4 Days |
| — | — | — | PT-3 | 180 Min. | 6 Days | PT-3 | 180 Min. | 6 Days |
| — | — | — | PT-4 | 480 Min. | 3 Days | PT-4 | 480 Min. | 3 Days |
| — | — | — | PT-5 | 240 Min. | 6 Days | PT-5 | 240 Min. | 6 Days |
| — | — | — | PT-6 | 360 Min. | 4 Days | PT-6 | 360 Min. | 4 Days |
| — | — | — | PT-7 | 360 Min. | 6 Days | PT-X | Variable | Variable |
| — | — | — | PT-8 | 600 Min. | 3 Days | — | — | — |
| — | — | — | PT-9 | 300 Min. | 6 Days | — | — | — |
| — | — | — | PT-10 | 360 Min. | 5 Days | — | — | — |

Notes:
^{(A)}Segmented into one hour blocks;
^{(B)}segmented into fifteen minute blocks;
^{(C)}segmented into 30 minute blocks.

Despite the latitude and variation available for defining the shifts, a few practical matters are noted.

First, the invention's ability to provide hiring suggestions correlates with both the number of shifts and the number of daily time segments set forth in an employer's shift definition. By providing more variety in the time segments throughout several predefined shifts, more options are available for finding shift and shift combinations that best match a desired work block. For example, using the shifts of “Shift Definition A” above, a 10 hour 6 day work block that needs to be covered can only be filled by either overstaffing or understaffing; whereas the same work block can be filled without any over or understaffing in two different ways selecting from the greater variety of shifts available in “Shift Definition B” (i.e., two Pt-8 shifts, or two PT-9 shifts). Even where overstaffing and understaffing is acceptable, the degree thereof can be more precisely controlled with a wider shift selection.

Second, if over and understaffing raises substantial concerns, such concerns can be mitigated by the using and/or defining a shift with variable daily and weekly time segments (e.g., “Shift PT-X” in “Shift Definition C”), provided such practice is not otherwise prohibited by local employment laws, contractual obligations, and/or an employer's hiring policies. Use of a variable shift would enable an employer to fill a residual work block for which no other predefined shift can perfectly fit. In the present invention, a variable shift would only be used in combination with other predefined fixed shifts.

And third, although not limited in theory, as a practical matter for most employers, the work week will likely always be either segmented into “days” or—less commonly—“half days”. The former needs no further explanation. As to the latter, half-day segments could be used by an employer to define a continuous 24-hour daily operation, each day being divided into a day shift and a night shift. For such employer, a week could be divided into 14 half day segments starting, for example, with a “Monday-Day Shift” and ending at “Sunday Night-Shift”. Other possibilities and arrangements would of course be available and apparent to those skilled in the art in light of the present disclosure.

Attention is now directed to “baseline staff”.

As used herein, the term “baseline staff” shall be defined as the set of employees retained by an employer for a first predetermined time and/or employment context (i.e., to meet the employer's “current staffing demand”), and wherein each employee in the set is associated with a particular shift. The “time and/or employment context” for the baseline staff is preferably “current permanent employment”, but can be configured to include other time periods and employment contexts.

As shown in the Example provided below, baseline staff is preferably inputted into a data array (i.e., a “work schedule”) comprising a “daily time segment dimension” (cf., the columns in Table 2 comprising hours of the day) and a “weekly time segment dimension” (cf., the rows in Table 2 comprising the days of the week). For each staff member within the baseline staff, data or other indication (such as a sequential numeric count) is added to the array that specifies which specific daily and weekly time segments are assigned to that staff member.

Thus, for example, a staff member employed as a full time permanent employee working 8-to-5 (i.e., 9 hours) Monday-to-Friday (i.e., 5 days) can be assigned to, and thereby counted within, a total of 45 array elements (i.e., representing the staff member's 45 total weekly hours) in a weekly data array comprising a total of 63 total weekly hours. This is done for each staff member such that total baseline staff coverage is inputted into and determinable from the weekly data array discretely (i.e., “cell-by-cell”).

The inputting of baseline staff is performed directly (such as by manual data entry) or indirectly (such as by retrieving and importing relevant staffing data, for example, from a remote central employee database). Employee databases maintained by large established organizations and commercial entities are typically massive stockpiles of worker-related data and may already include specific daily and weekly time assignments. Importing, mapping, transferring, or otherwise accommodating such data into the data arrays of the present invention could be accomplished effectively through known data retrieving, filtering, counting, and formatting processes. Automated importation of data from such employee databases, as performed in preferred embodiments, promotes preparedness of and currency in staff forecast calculations, accommodating flux caused by employee attrition, transfers, reassignments, and the like.

In assigning coverage within a weekly data array, for example, it is not a technical limitation to the invention that an employee's daily or week time segments be consecutive. An employee working a 3-day week, can be assigned to consecutive days (e.g., Monday to Wednesday) or non-consecutive days (e.g., Monday, Friday, and Saturday). Likewise, an employee assigned to a 6-hour day need not necessarily be assigned to six consecutive hours. As a practical matter, however, employment situations necessitating the assignment of several inconsecutive hours for a single employee within a single day are likely to be exceedingly uncommon, if not categorically undesirable.

Although not shown in the example herein, inputting coverage can include breaks (e.g., lunch breaks). For example, a 9-hour daily shift can include a predefined 1-hour lunch break. Accommodating and recording such breaks within the data array would be within the skill in the art. Typical approaches and mechanisms could entail, for example differentiating “break” data types from “on hand” data types, not counting as “covered” or “assigned” an employees lunch break, and/or filtering out lunch breaks from imported employee schedules.

Inputted coverage can also represent a zero-staff baseline, for example, by entering a zero at each discrete work block in a data array. This would be particularly relevant for generating staffing suggestions providing coverage, for example, for a newly launched facility, store, site or branch.

Attention is now directed to “projected staff”.

As used herein, the term “projected staff” shall be defined as the set of employees to be retained by an employer at a second calculated time and/or employment context (i.e., to meet the employer's “future staffing demand”), and wherein each employee in the set is associated with a particular shift. The “time and/or employment context” for the projected staff is preferably “future temporary employment”, but—like baseline staff—can be configured to include other time periods and employment contexts.

The projected staff data is preferably inputted as or into a work schedule data array similar, if not identical, in format to that used for the baseline staff, i.e., a 2D-array having “a daily time segment dimension” and a “weekly time segment dimension”. Although this data can be derived and inputted manually, in the preferred methodology the data is first computationally generated, then imported, extracted, assigned, or transferred as or into the data array. One or several user interfaces can be used for prompting and receiving the data input, wherein “inputting” is executed through a single step or several related steps.

Unlike the “baseline staff” data, which relies directly and largely upon an actual “headcount”, the projected staff data is a forecast that requires, and results from, computational processing of a larger set of related extrinsic data and variables. Such extrinsic data and variables can include, for example, historical staffing data, competitor staffing data, regional labor statistics, regional economic data, seasonal variables, temporal variables, pattern-based mathematical models, product sales forecast data, employee retention data, and electronic data collected from employee activity and productivity sensors and monitors. The result of the computational processes executed on such extrinsic information results preferably in the projected staff array data, wherein the data type of the array is the same as that used for the baseline staff array data, thereby facilitating the calculation of the variance (cf., the “gap”) therebetween.

The computational processes used for forecasting staffing demand can be based on, for example, “forward-looking heuristic algorithms”, “predefined staffing templates”, and/or “historical staffing data”. The implementation of such computation processes is well known in the art. See e.g., U.S. Pat. No. 7,925,521, issued to B. Backhaus et al. on Apr. 12, 2011; U.S. Pat. No. 8,374,982, issued to J. Z. Shan et al. on Feb. 12, 2013; U.S. Pat. No. 8,260,649, issued to S. Ramanujan et al. on Sep. 4, 2012; and U.S. Pat. No. 7,478,051, issued to I. Nourbakhsh et al. on Jan. 13, 2009.

The use of a forward-looking staffing heuristic algorithm would typically involve submitting historical and/or baseline staffing data through a sequence of pattern and behavior recognition engines, approximation engines and filters, and programmed optimization, parsing, data shaping, queuing, and statistical routines. As is well known, however, the study and application of heuristics is currently a broad and active field in computer engineering. Accordingly, the term “heuristic algorithm” as used herein is intended to encompasses any computational process wherein the “projected staff data” is extrapolated from actual staffing data based on mathematical assumptions and approximations, regardless of the particular constituency and specific implementation thereof.

In contrast, the “projected staff data” can also be provided perhaps more simply through the use of predefined staffing templates. Libraries of such templates, representing various employment scenarios, can be stored in an employer database, and retrieved as circumstance warrants (e.g., periodic scheduled human resource maintenance), or automatically, upon the setting off of predefined triggers (e.g., a date based trigger). The templates themselves can contain static data (e.g., a fixed headcount schedule for the Christmas season) or dynamic formula (e.g., a multiplier used to calculate additional headcount for the Christmas season).

Likewise, the “projected staff data” can also be provided through calculating an average of historical staffing data. For example, a retail employer wishing to plan temporary staffing for an upcoming Christmas season can generate “projected staff data” by retrieving actual staffing data from the several past Christmas seasons, and using an average thereof as the “projected staff data”, either without further processing or adjusted according to other predefined variables (e.g., a multiplier based on contemporaneous financial performance data).

In addition to the “projected staff data” and the “baseline staff data”, in generating a “forecasted staff report”, the present invention relies also upon at least one predefined “staffing constraint”.

The staffing constraint can be any factor or set of circumstances that would limit or otherwise influence an employer's ability, extent, or manner in or to which a variance between “projected” and “baseline” staff data is filled. For example, an employer may need to fill three part-time shifts, but due to a staffing allowance, may only be able to hire only two part-time employee. In another example, an employer needing to fill a 12-hour shift may be required by a union contract to hire no employee for more than 9 hours. And, in still another example, an employer seeking to fill several varying positions and shifts may be required by a national law to specify contractually the exact day and times each new hire is expected to work, thus calling for discrete scheduling. In each of these case, the “staffing constraint” clearly influences hiring in respect of ability, extent, and manner.

As to implementation, the “staffing constraint” is defined through mathematical expression, i.e., an expression that represents and thereby embodies the constraint or the effect thereof. A staffing constraint definition can be, for example, a single fixed integer or sets thereof, each representing a minimum or maximum number of employees that can be hired by the employer under corresponding sets of one or several predefined conditions. Alternatively, a staffing constraint definition can be a programmed function or variable, such as a variable percentage (e.g., applicable to a fixed headcount number) that rises or falls based on other economic variables. The staffing constraint definition can also be expressed as a boolean, such as one conditioned on location or geography and which would be particularly useful in representing the jurisdictions of regulatory constraints.

As will be appreciated, there are several paths available for expressing staffing constraints. Regardless, whether expressed in a single number or through several lines of code, the staffing constraint definition is programmed and/or otherwise embodied in formats, modules, and/or routines that enable the staffing constraint represented thereby to influence the result of variance calculations on the invention's forecasted staff report.

Like the means of expression, the types of constraints are also variable. Two particular classes of constraints however are of particular note: i.e., “budgetary” and “regulatory” constraints.

As used herein, a “budgetary constraint” shall encompass any constraint on staffing related to economic factors. Economic factors shall include, but not limited to, an employer's “staffing allowance” (e.g., as could be set by an employer's human resources department); an employer's fiscal performance; branch or divisional sales; national or regional employment statistics, national or regional economic forecasts; and financial indices, rates, ratings, and indicators provided by banking institutions and national and international economic organizations.

As used herein, a “regulatory constraint” shall encompass any constraint on staffing related to the laws, rules, regulations, policies, guidelines, and standards of any government, administrative or juridical body, sovereign, industrial organization, trade associations, or labor union. Examples of such constraints include, for example, a national law restricting the terms for contract and seasonal labor; a national law requiring employee benefits that could increase employment and hiring costs; a union contract with terms governing the hiring of full-time permanent union employees and temporary employees, and a national law prohibiting and/or otherwise restricting work hours.

In accordance with the principle objectives of the invention, the variance (or gap) between baseline and projected staff is calculated discretely. In particular, this is accomplished by calculating variance for each individual daily and weekly time segment. Thus, where shifts are segmented into hours and day, the difference between baseline and projected staff coverage for each hour and each day is calculated.

These calculation alone can be sufficient to enable the identification by suitable computer programming of gaps in staffing coverage. Preferably, however, further programming can also include, for example, summation of head count at each daily segment (see e.g., Table 3 of the Example provided below); summation of head count at each weekly time segment; averaging between adjacent daily time segments or blocks thereof (which may be useful, e.g., for plotting charts or advanced optimization algorithms); calculating standard deviations (which may be involved, e.g., in determining variance in large employee populations); or density calculations (which may be used, e.g., for identifying “hot spots” for targeted staffing).

Further, within each discrete cell of a staff data array, variance can be expressed either as an absolute number (e.g., “−3 employees”, “+5 employees” or “0 employees”) or a relative number (e.g., “−100% of demand” or “+35% of demand”). Such calculation is particularly relevant for embodiments of the invention that rely primarily upon the use of commercially-available spreadsheets and databases. Greater latitude in calculation, manipulation, and presentation of variance (and staffing data) can, of course, be accomplished through custom developed and engineered programming.

With variance calculated and constraints defined, a “forecasted staff report” is subsequently prepared that provides information composed as a function of both these variables. In the preferred embodiments, this information includes: a discrete identification of staffing surpluses and/or deficits, an identification of applied constraints, and—if deficits are identified—an identification of staffing data (cf., “staffing suggestions”) that is (a) relevant to filling said deficits and (b) analyzed in view of said constraints.

With regard to “staffing suggestions”, it is preferred that the staffing deficits are “filled” using the “set of shifts” defined within the inventive methodology, rather than suggesting or creating new ones. In some instances, matching the existing shifts to the identified deficits may lead to understaffing or overstaffing at certain discrete time segments. This should be expected more so where shift definitions are comparatively few and narrow, and thus, provider fewer alternative shift combinations. Nonetheless, algorithms for optimizing shift-to-deficit matching, or otherwise accommodating any residual disparities therein to predefined acceptable levels, is within the skill in the art.

The “staffing suggestion” can be engineered to factor in other variables aside from gap filling and the predefined constraints. For example, costs difference between different shifts and shift combinations can be factored into the suggestion. Where several combinations are possible, the forecasted staff report can either identify the least costly of the combinations alone and/or provide a list of all or several such combinations ordered by ascending or descending costs.

It is further preferred that staffing suggestions culled from predefined shifts be presented with information that specifically sets forth the discrete working schedules for each shift. This would be particularly relevant in jurisdictions that require disclosure of such information as a condition of employment. Example of such discrete working schedules can be found in Tables 4(a) and 4(b) below, which not only identifies possible shift combinations that could cover identified deficits, but also, the detailed working schedules for each proposed shift.

The forecasted staff report can be embodied as any computer implemented instrumentality or device suitable for presenting the result of constraint and variance data processing as performed pursuant to the invention. The staffing report need not be limited to a single page, screen, window, and/or display. Information can be provided over several such instrumentalities, which further, can be provided either automatically (cf., triggered) or accessed through menus, callable functions, layout selections, embedded pre-programmed macros, and the like. Furthermore, the information can be presented as, or include, graphs, tables, diagrams, and/or narrative text.

To further illustrate the invention as described above, the following example is provided to show specific details of one particular embodiment of the invention.

### Example

Two forecasted staff reports are generated through a computer-implemented methodology, which commences with the preparation of a data array wherein a set consisting of four shifts is defined. The four shifts—named “FT-1”, “FT-2”, “PT-1”, and “PT-2” are shown in the following Table 1 (representing said data array).

TABLE 1
Shift Definition

| | Daily Shift | Days | Total | | |
|---|---|---|---|---|---|
| Shift | Length | Per | Weekly | Shift | |
| Name | (Hours) | Week | Hours | Type | Staff |
| FT-1 | 9 | 5 | 45 | Full Time | 5 |
| FT-2 | 8 | 6 | 48 | Full Time | 5 |
| PT-1 | 4 | 5 | 20 | Part Time | 5 |
| PT-2 | 5 | 4 | 20 | Part Time | 5 |

In Table 1, each shift definition comprises “daily time segments” (cf., “Hours”) and “weekly time segments” (cf., “Days”). Details of the “Shift Type” and current headcount (cf., “Staff”) are also provided, together with a summation of “Total Weekly Hours”.

Following shift definition, “baseline staff” is then inputted into another data array, representing a “work schedule” covered by the “baseline staff” to meet a current staffing demand. This “work schedule” is illustrated in the following Tables 2a and 2a.

Tables 2a are 2b are similar. Both provide assigned headcount data for each discrete daily work hour block. The headcount data in Table 2A, however, is broken down into shifts using the following format: “FT-1”/“FT-2” <Break> “PT-1”/“PT-2”. The headcount data in Table 2B is the sum of all assigned shifts.

TABLE 2a
Baseline Staff

| | 8:00 | 9:00 | 10:00 | 11:00 | 12:00 | 1:00 | 2:00 | 3:00 | 4:00 |
|---|---|---|---|---|---|---|---|---|---|
| Monday | 5/0 | 5/5 | 5/5 | 5/5 | 5/5 | 5/5 | 5/5 | 5/5 | 5/5 |
| | 0/0 | 0/0 | 0/0 | 0/0 | 0/0 | 0/0 | 0/0 | 0/0 | 0/0 |
| Tuesday | 5/0 | 5/5 | 5/5 | 5/5 | 5/5 | 5/5 | 5/5 | 5/5 | 5/5 |
| | 0/0 | 0/0 | 0/0 | 0/0 | 0/0 | 0/0 | 0/0 | 0/0 | 0/0 |
| Wednesday | 0/0 | 0/5 | 0/5 | 0/5 | 0/5 | 0/5 | 0/5 | 0/5 | 0/5 |
| | 5/0 | 5/0 | 5/0 | 5/0 | 0/0 | 0/0 | 0/0 | 0/0 | 0/0 |
| Thursday | 0/0 | 0/5 | 0/5 | 0/5 | 0/5 | 0/5 | 0/5 | 0/5 | 0/5 |
| | 5/0 | 5/0 | 5/0 | 5/0 | 0/5 | 0/5 | 0/5 | 0/5 | 0/5 |
| Friday | 5/0 | 5/5 | 5/5 | 5/5 | 5/5 | 5/5 | 5/5 | 5/5 | 5/5 |
| | 5/0 | 5/0 | 5/0 | 5/0 | 0/5 | 0/5 | 0/5 | 0/5 | 0/5 |
| Saturday | 5/0 | 5/5 | 5/5 | 5/5 | 5/5 | 5/5 | 5/5 | 5/5 | 5/5 |
| | 5/0 | 5/0 | 5/0 | 5/0 | 0/5 | 0/5 | 0/5 | 0/5 | 0/5 |
| Sunday | 5/0 | 5/0 | 5/0 | 5/0 | 5/0 | 5/0 | 5/0 | 5/0 | 5/0 |
| | 5/0 | 5/0 | 5/0 | 5/0 | 0/5 | 0/5 | 0/5 | 0/5 | 0/5 |

TABLE 2b
Baseline Staff

| | 8:00 | 9:00 | 10:00 | 11:00 | 12:00 | 1:00 | 2:00 | 3:00 | 4:00 |
|---|---|---|---|---|---|---|---|---|---|
| Monday | 5 | 10 | 10 | 10 | 10 | 10 | 10 | 10 | 10 |
| Tuesday | 5 | 10 | 10 | 10 | 10 | 10 | 10 | 10 | 10 |
| Wednesday | 5 | 10 | 10 | 10 | 5 | 5 | 5 | 5 | 5 |
| Thursday | 5 | 10 | 10 | 10 | 10 | 10 | 10 | 10 | 10 |
| Friday | 10 | 15 | 15 | 15 | 15 | 15 | 15 | 15 | 15 |
| Saturday | 10 | 15 | 15 | 15 | 15 | 15 | 15 | 15 | 15 |
| Sunday | 10 | 10 | 10 | 10 | 10 | 10 | 10 | 10 | 10 |

In the “Baseline Staff” tables above, work schedule coverage is assigned as follows: All FT-1 headcount us assigned to work Friday to Tuesday from 8 to 5; all FT-2 headcount is assigned to work Monday to Saturday from 9 to 5; all PT-1 headcount is assigned to work Wednesday to Sunday from 8 to 12; and all PT-2 head count is assigned to work from Thursday to Sunday from 12 to 5.

With “Baseline Staff” discretely entered into the work schedule, projected staff intended to cover an upcoming holiday season is determined. In this example, it is forecasted that during the holiday season, there will be a 10% increase in customer traffic for all hours of the work schedule from Monday to Thursday, and a 15% increase, Friday to Sunday. Assuming a 1:1 relationship between customer traffic and staffing demand, based on the projected staff coverage calculated as a whole number (i.e., an integer data type) from Table 2B above, the variance between “Projected Staff” and “Baseline Staff” is provided for each discrete daily hour segment in Table 3 below.

TABLE 3
Projected Staff Variance

| | 8:00 | 9:00 | 10:00 | 11:00 | 12:00 | 1:00 | 2:00 | 3:00 | 4:00 |
|---|---|---|---|---|---|---|---|---|---|
| Monday | 0 | −1 | −1 | −1 | −1 | −1 | −1 | −1 | −1 |
| Tuesday | 0 | −1 | −1 | −1 | −1 | −1 | −1 | −1 | −1 |
| Wednesday | 0 | −1 | −1 | −1 | 0 | 0 | 0 | 0 | 0 |
| Thursday | 0 | −1 | −1 | −1 | −1 | −1 | −1 | −1 | −1 |
| Friday | −1 | −2 | −2 | −2 | −2 | −2 | −2 | −2 | −2 |
| Saturday | −1 | −2 | −2 | −2 | −2 | −2 | −2 | −2 | −2 |
| Sunday | −1 | −1 | −1 | −1 | −1 | −1 | −1 | −1 | −1 |
| TOTAL | −3 | −9 | −9 | −9 | −8 | −8 | −8 | −8 | −8 |

In Table 3, for the upcoming holiday season, the employer is short two employee assignments from 9:00 to 5:00 on Friday and Saturday and one employee assignment in most of the other remaining blocks of the work schedule.

With the gaps in staffing identified, a staffing forecast is provided by matching (via computer) potential shift combinations with discretely scheduled hours to the identified variance, together with or otherwise in light of the enforcement of at least one predefined staffing constraint. For the present example, the staffing constraint is defined to be a function based on the acceptability or unacceptability of “understaffing” (i.e., having less than the staff needed to cover a projected work schedule).

Depending on whether the understaffing constraint function is triggered or otherwise activated to either allow “understaffing” or reject “understaffing”, the information provided in the “Forecasted Staff Report” will differ, as shown in the following Tables 4a and 4b.

TABLE 4a
Forecasted Staff Report (Constraint: Understaffing - “Acceptable”).

| | Shift | Weekly | Scheduled Hours | | | | | | |
|---|---|---|---|---|---|---|---|---|---|
| Staff | Type | Hours | Mon. | Tue. | Wed. | Thu. | Fri. | Sat. | Sun. |
| 1 | FT-1 | 45 | 9-5 | 9-5 | — | 9-5 | 9-5 | 9-5 | 9-5 |
| 2 | PT-1 | 20 | — | — | 9-2 | 9-2 | 9-2 | 9-2 | — |

| | 8:00 | 9:00 | 10:00 | 11:00 | 12:00 | 1:00 | 2:00 | 3:00 | 4:00 |
|---|---|---|---|---|---|---|---|---|---|
| Monday | +1 | 0 | 0 | 0 | 0 | 0 | 0 | 0 | 0 |
| Tuesday | +1 | 0 | 0 | 0 | 0 | 0 | 0 | 0 | 0 |
| Wednesday | 0 | 0 | 0 | 0 | 0 | +1 | +1 | 0 | 0 |
| Thursday | 0 | 0 | 0 | 0 | 0 | 0 | −1 | −1 | −1 |
| Friday | 0 | 0 | 0 | 0 | 0 | 0 | −1 | −1 | −1 |
| Saturday | 0 | 0 | 0 | 0 | 0 | 0 | −1 | −1 | −1 |
| Sunday | 0 | 0 | 0 | 0 | 0 | 0 | 0 | 0 | 0 |

Table 4a provides a staffing suggestion for filling the projected staff gaps comprising two new temporary employee positions (i.e., Staff 1 and Staff 2); each having shifts selected from the shift definitions set forth in Table 1 above (i.e., FT-1 and PT-2, respectively); and each having discrete daily and weekly schedules (i.e., a Thursday-Tuesday 9:00-5:00 schedule and a Wednesday-Saturday 9:00-2:00 schedule, respectively). The work schedule array following the Staffing Report reveals the “understaffing” that exists from 2:00 to 5:00, which is acceptable pursuant to the understaffing constraint.

TABLE 4b
Forecasted Staff Report (Constraint: Understaffing - “Unacceptable”).

| | Shift | Weekly | Scheduled Hours | | | | | | |
|---|---|---|---|---|---|---|---|---|---|
| Staff | Type | Hours | Mon. | Tue. | Wed. | Thu. | Fri. | Sat. | Sun. |
| 1 | FT-1 | 45 | 9-5 | 9-5 | — | 9-5 | 9-5 | 9-5 | 9-5 |
| 2 | PT-1 | 20 | — | — | 9-2 | 9-2 | 9-2 | 9-2 | — |
| 3 | PT-1 | 20 | — | — | 12-5 | 12-5 | 12-5 | 12-5 | — |

| | 8:00 | 9:00 | 10:00 | 11:00 | 12:00 | 1:00 | 2:00 | 3:00 | 4:00 |
|---|---|---|---|---|---|---|---|---|---|
| Monday | +1 | 0 | 0 | 0 | 0 | 0 | 0 | 0 | 0 |
| Tuesday | +1 | 0 | 0 | 0 | 0 | 0 | 0 | 0 | 0 |
| Wednesday | 0 | 0 | 0 | 0 | +1 | +2 | +2 | +1 | +1 |
| Thursday | 0 | 0 | 0 | 0 | +1 | +1 | 0 | 0 | 0 |
| Friday | 0 | 0 | 0 | 0 | +1 | +1 | 0 | 0 | 0 |
| Saturday | 0 | 0 | 0 | 0 | +1 | +1 | 0 | 0 | 0 |
| Sunday | 0 | 0 | 0 | 0 | 0 | 0 | 0 | 0 | 0 |

Table 4b—in contrast to Table 4a—provides a staffing suggestion that comprises three new temporary employee positions (i.e., Staff 1, Staff 2, and Staff 3); each having shifts selected from the shift definitions set forth in Table 1 above (i.e., FT-1, PT-1, and PT-1, respectively); and each having discrete daily and weekly schedules (i.e., a Thursday-Tuesday 9:00-5:00 schedule, a Wednesday-Saturday 9:00-2:00 schedule, and a Wednesday-Saturday 12:00-5:00 schedule, respectively). As with Table 4a, the work schedule array following the Staffing Report 4B reveals no “understaffing” throughout the entire work schedule, consistent with the unacceptability thereof, as per the understaffing constraint.

In sum, Tables 4a and 4B above each provide a forecasted staff report comprising information (i.e., suggested staffing schedules) composed as a function of both variance (i.e., matching based on the gap data provided in Table 3) and a predefined staffing constraint (i.e., “understaffing”).

Although several embodiments of the invention are disclosed hereinabove, those skilled in the art having the benefits of this disclosure can effect modifications thereto. These modifications are to be construed as being encompassed within the scope of the present invention as set forth in the appended claims.

1. A computer implemented method for generating a forecasted staff report, the method comprising the steps of:
defining a set of shifts, each shift having daily time segments and weekly time segments;
inputting baseline staff covering a work schedule using said set of shifts to represent current staff;
providing projected staff anticipated to cover said work schedule to meet a future staffing demand;
defining at least one staffing constraint;
calculating variance between the baseline staff and the projected staff for each daily and weekly time segment; and
providing the forecasted staff report, the report comprising information composed as a function of both said variance and said staffing constraint.

2. The computer implemented method of claim 1, wherein said information of said forecasted staff report comprises at least one staffing suggestion covering a shift selected specifically from said defined set, and wherein said selection is a function of both said variance and said staffing constraint.

3. The computer implemented method of claim 1, wherein said at least one staffing constraint is a budgetary constraint.

4. The computer implement method of claim 1, wherein said at least one staffing constraint is a regulatory constraint.

5. The computer implemented method of claim 2, wherein the provision of said projected staff is based on a forward-looking heuristic algorithm.

6. The computer implemented method of claim 2, wherein the provision of said projected staff is based on a predefined staffing template.

7. The computer implemented method of claim 2, wherein the provision of said projected staff is based on a calculated average of historical staffing data.

8. The computer implemented method of claim 1, wherein the baseline staff is inputted automatically through importation of staffing data stored at an employee database.

9. A computer implemented method for generating a forecasted staff report, the method comprising the steps of:
defining a set of shifts, each shift having daily time segments and weekly time segments;
inputting baseline staff covering a work schedule using said set of shifts to represent current staff;
providing projected staff anticipated to cover said work schedule to meet a future staffing demand;
calculating variance between the baseline staff and the projected staff for each daily and weekly time segment; and
providing the forecasted staff report, the report comprising information composed as a function of said variance.

10. The computer implemented method of claim 9, wherein said information of said forecasted staff report comprises at least one staffing suggestion providing a shift selected specifically from said defined set, and wherein said selection is a function of said variance.

11. The computer implemented method of claim 10, wherein the baseline staff is inputted automatically through importation of staffing data stored at an employee database.
